(19) United States
(12) Patent Application Publication
(10) Pub. No.: US 2015/0214517 A1
(43) Pub. Date: Jul. 30, 2015

(54) FILM FOR PROTECTING ELECTROCHEMICAL ENERGY STORES

(71) Applicants: Heidi Schneider, Grossschirma / OT Siebenlehn (DE); Andreas Trinczek, Wittichenau (DE); Iris Stiebert, Dresden (DE); Frank Rietschel, Pulsnitz (DE); Holger Mikus, Kamenz (DE)

(72) Inventors: Heidi Schneider, Grossschirma / OT Siebenlehn (DE); Andreas Trinczek, Wittichenau (DE); Iris Stiebert, Dresden (DE); Frank Rietschel, Pulsnitz (DE); Holger Mikus, Kamenz (DE)

(73) Assignee: LI-TEC BATTERY GMBH, Kamenz (DE)

(21) Appl. No.: 13/997,126

(22) PCT Filed: Dec. 19, 2011
(86) PCT No.: PCT/EP2011/006413

§ 371 Date: Sep. 25, 2013

(30) Foreign Application Priority Data
Dec. 21, 2010 (DE) 10 2010 055 401.4

(51) Int. Cl. H01M 2/08; B05D 1/02; B05D 5/00; B32B 37/18

(52) U.S. Cl. CPC H01M 2/08; B32B 37/18; B05D 1/02; B05D 5/00; B32B 2457/10

(57) ABSTRACT

The invention relates to a film for protecting the housing surface or the packaging surface of electrochemical energy stores from damage, in particular during production, during transport, or at the time of installation of such electrochemical energy stores.

The entire content of the priority application DE 10 2010 055 401.4 is hereby made a component of the present application by reference.

The present invention relates to a film for protecting the housing surface or the packaging surface of electrochemical energy stores, particularly galvanic cells, from damage, a method for producing an electrochemical energy store and an electrochemical energy store.

Batteries (primary stores) and accumulators (secondary stores) for the storage of electrical energy, which are made up of one or a plurality of storage cells in which electrical energy is converted into chemical energy and therefore stored when a charging current is applied in an electrochemical charging reaction between a cathode and an anode in or between an electrolyte and in which chemical energy is converted into electrical energy in an electrochemical discharge reaction when an electrical consumer is applied, are known in the art. In this case, primary stores are usually only charged once and are disposed of following discharge, while secondary stores allow a plurality (from a few 100 to over 10,000) of charging and discharging cycles. It should be noted in this respect that accumulators are sometimes also referred to as batteries, such as vehicle batteries, for example, which are generally known to undergo frequent charging cycles.

In recent years primary and secondary stores based on lithium compounds have gained in significance. These stores exhibit a high energy density and thermal stability, supply a constant voltage with low self-charging and are free from memory effect.

It is known in the art for energy stores and particularly lithium batteries and accumulators to be produced in the form of thin plates. With cells of this kind, cathode and anode material, electrodes and separators are laid on top of one another (stacked) in a suitable manner in the form of thin films and packed into a film packing made of a composite material, wherein current conductors project laterally on one edge of the cell.

During production, transportation and installation of the energy store into its application environment, the film packaging is exposed to the risk of damage, particularly by scratching and puncturing, as a result of which the tightness of the film packaging of the energy store can be adversely affected.

The problem addressed by the present invention is therefore that of improving or mitigating this situation. This problem is solved by a product according to one of the independent product claims or by a method according to one of the independent process claims. The dependent claims are intended to protect advantageous developments of the invention.

A film for protecting the housing surface or the packaging surface of electrochemical energy stores from damage, particularly during the production, transportation or installation of such electrochemical energy stores, is provided according to the invention. The film according to the invention is also referred to as protective film in the following, simply to differentiate it from other films.

In this context, a film is taken to mean a thin, preferably leaf-shaped, object or a thin material layer, which is preferably applied or may be applied to the surface of an object. Preferred materials in this case are metals or plastics. Films are preferably initially produced in continuous webs, rolled up and later cut into suitable pieces. Plastic films are preferably made of polyolefins, such as high or low-density polyethylene or polypropylene. In addition to these, however, polyvinyl chloride, polystyrene or various polyesters, as well as polycarbonate, are suitable for the production of plastic films, for example. The mechanical load capacity of such films can preferably be increased by reinforcement with fibres, preferably glass fibres, or by introducing a mesh. Likewise, certain additives, preferably polymers, increase the thermal capacity of such films.

This film is preferably constructed in such a way that it can be removed substantially residue-free from the housing surface or from the packaging surface of electrochemical energy stores. One possible way of achieving this is for the film's adhesive coating to be dispensed with and adhesion of the protective film on the housing surface or of the packaging surface of the electrochemical energy store to be realized through direct adhesion or cohesion of the materials or material. Adhesives also exist, however, which remain practically completely on the protective film when the protective film is removed from the housing surface. The chemical and physical composition of these adhesives depends on the materials used to produce the housing surfaces or the packaging surfaces of the electrochemical energy store.

This film preferably exhibits a pull-off tab, with the help of which said film can easily be removed again from the housing surface or from the packaging surface of the electrochemical energy store. This pull-off tab is preferably not coated with an adhesive, namely preferably even if the protective film, the removal of which it is intended to facilitate, is partially or completely coated with an adhesive. The surface of the pull-off tab preferably has a dimpled, rippled or other structure which increases friction in some other way, as a result of which the protective film becomes even easier to pull off.

It is preferably a multi-layer film, particularly preferably a laminated bundle comprising a plurality of films, which are preferably made of different materials or exhibit different materials. Multi-layer films of this sort are preferably also produced as multi-layer composites made of a combination of different plastics. In this way certain properties, such as the permeation behaviour, for example, can be improved. Apart from plastic films, metal films are preferably also processed in this way into multi-layer composites of this sort.

The film is preferably coated on at least one side at least partially with an adhesive. This adhesive particularly preferably exhibits a polyacrylate and/or an isocyanate or contains a polyacrylate and/or an isoacrylate. The film is preferably coated on at least one side at least partially with an acrylate dispersion, in other words, a dispersion comprising a polyacrylate.

The film preferably sticks by adhesion to the housing surface or to the packaging surface of electrochemical energy stores. Adhesion (cf. Latin adhaerere “to adhere”), also referred to as adhesive force or adhesion force, is the physical state of an interface layer which is configured between two condensed phases coming into contact—in other words, between solids and liquids with negligible vapour pressure. The main feature of this state is the mechanical cohesion of the phases involved created by molecular interactions in the interface layer. The forces causing this mechanical cohesion have not all been fully explored, which is why different adhesion theories exist (http://de.wikipedia.org/wiki/Adhäsion). Adhesion comprises the adhesive forces on the contact surfaces of two different or identical materials through molecular forces. The materials may be in a solid or liquid state. In the field of adhesives, adhesion is understood to mean the bonding of adhesive layers on the assembly component surfaces. The processes involved in adhesion are not yet fully understood. They are made particularly difficult, because the dependencies between the adhesive systems and the different assembly component surfaces are highly complex. Adhesive films cling to smooth/shiny surfaces without adhesive by means of the molecular attraction between the two materials. The precondition is that the molecules get as close as possible, in order to achieve adhesion.

The film preferably behaves in a chemically inert manner in relation to those parts of the housing surface or of the packaging surface of electrochemical energy stores with which it comes into contact. This is preferably achieved in that the protective film or that layer of the protective film that comes into contact with the housing surface or with the packaging surface of the electrochemical energy store is made of the same or of a chemically similar material as the housing surface or the packaging surface of the electrochemical energy store.

A method for producing an electrochemical energy store, in which at least one film according to one of the preceding claims is applied at least partially to the housing surface or to the packaging surface of the electrochemical energy store, is also provided according to the invention.

A method is preferably provided in which the film is applied free from folds and without air pockets.

A method is preferably provided in which the film is applied during production thereof, during deep drawing or during subsequent steps involved in the production of the electrochemical energy store. In this context, the term “deep drawing” should also include thermoforming and similar production methods. DIN 8584 describes deep drawing as the tensile-compressive reforming of a sheet metal part (also referred to as a round, film, plate, sheet or blank) into a hollow body open on one side or of a projected hollow body into one with a smaller cross-section, without intentionally altering the sheet thickness (http://de.wikipedia.org/wiki/Tiefziehen). A round cut-to-size piece is also referred to as a round. Deep drawing numbers among the most important sheet metal reforming processes and is used both in mass production and also in small-scale series production, such as in the packing and automobile industry and in aircraft construction, for example.

Thermoforming is a method of reforming thermoplastic plastics. It was previously referred to as hot forming, deep drawing or vacuum deep drawing (http://de.wikipedia.org/wiki/Thermoformen). Thermoforming methods are distinguished according to the semi-finished product: thinner semi-finished products are referred to as films, thicker ones (from approx. 1.5 mm) as plates. Film semi-finished products may be fed to the thermoforming machines on large (up to 1.8 m diameter) rolls.

A method is preferably provided in which the film is glued on, laminated on, coated or sprayed onto the housing surface or onto the packaging surface of the electrochemical energy store. Lamination (or laminating) refers to the connection of a thin, frequently film-like, layer to a carrier material by means of an adhesive (http://de.wikipedia.org/wiki/Laminieren).

A method is preferably provided in which a multi-layer film is preferably applied layer by layer to the housing surface or to the packaging surface of the electrochemical energy store.

According to the invention, an electrochemical energy store is also provided with a film according to one of the preceding product claims or produced with a film according to one of the preceding process claims.

The invention is described in greater detail below with the help of preferred exemplary embodiments. Features of these or other exemplary embodiments of the invention can be combined with features of further exemplary embodiments, so that further exemplary embodiments of the invention are thereby achieved.

A typical electrical energy storage cell according to the device is equipped with an active part, which is set up and adapted to store electrical energy supplied from outside. It further exhibits a casing or film packaging made of a film material, which encases the active part preferably in a gas-tight and liquid-tight manner. Moreover, its exhibits at least two current collectors, which are connected to the active part and are set up and adapted to feed electrical current from the outside to the active part and to deliver electrical current delivered by the active part to the outside, wherein the part encased by the casing delineates a preferably prismatic structure of substantially rectangular form, the extension whereof in a first spatial direction is preferably considerably smaller than the extension in the two remaining spatial directions, so that essentially two planar sides opposite one another, which are substantially parallel, and four narrow sides connecting the two planar sides are defined and wherein the first and the second current conductors project from the casing preferably parallel to the planes of the two planar sides in opposite directions from two opposite narrow sides.

The electrochemically active constituents of electrochemical energy stores are preferably shrink-wrapped in an aluminium composite film, namely such that extended sections of the current-collecting films pass through the weld seam on one side in each case and project outwardly as connections or current conductors. These are preferably jointly conducted outwards through a weld seam of the composite film or the ends of the current-collecting films are concentrated within the film packaging and connected by connecting means such as rivets, for example, which run through the film packaging perpendicularly, to a rod-shaped current conductor lying on the outside of the film packaging.

The casing of the energy store preferably exhibits a film packaging, particularly preferably a laminated film or a laminated bundle of films, which encases the laminate comprising electrodes and dividing layers in a gas- and liquid-tight manner. In particular, the casing may exhibit a first insulating layer, a conductor layer and a second insulating layer, wherein the insulating layers preferably exhibit a plastic or are made of a plastic of this kind.

The conductor layer preferably consists of aluminium or an aluminium alloy or another metal or another metal alloy, or it comprises aluminium or an aluminium alloy or another metal or another metal alloy. In this way, various functions and properties of the casing, such as weldability, mechanical strength, electrical and magnetic shielding, leak tightness in respect of liquids, vapours and gases, particularly water, water vapour and air, can be satisfied from outside and resistance to acids and electrolyte can be satisfied from inside in the same way or simultaneously.

The casing is preferably designed such that it exhibits at least one weld seam, preferably two weld seams extending along opposite narrow sides, also particularly preferably one weld seam which extends beyond one of the two planar sides or along a third narrow side or such that it exhibits two partial films which are welded to one another along the narrow sides.

One embodiment is configured such that at least one of the current conductors exhibits an inner part, which is located within the casing, and an outer part, which is located outside the casing, wherein the inner part of the current conductor is connected to the active part of the storage cell. In particular, the at least one current conductor can be guided through a weld seam in the casing. This configuration produces a particularly smooth, flat contour of the cell.

Alternatively, at least one of the current conductors may lie on the outside of the casing and be in contact with the active part through the casing. This configuration displays great robustness.

The invention is suitable for all kinds of electrical energy storage cells, in which the storage and delivery of electrical energy takes place through respective electrochemical reactions. A particularly flat embodiment of the active part, which substantially determines the thickness of the cell, is achieved by a laminated configuration with films of chemically active materials, electrically conductive materials and separating materials in suitable layering. In this way, the active part may exhibit a plurality of electrodes of two kinds, wherein an electrode of a first kind in each case is separated by a separating layer from the electrode of a second kind, wherein the electrodes of the first kind and the electrodes of the second kind are each connected to one another and to one of the current conductors.

The film packaging preferably exhibits a plurality, particularly preferably three, layers, this guaranteeing both satisfactory mechanical strength and also resistance to electrolyte material and good electrical and thermal insulation. The film packaging therefore preferably exhibits an inner layer of a thermoplastic such as polyethylene or polypropylene, a middle layer of a metal or aluminium, for example, and an outer layer of a plastic such as polyamide.

During production of the energy stores, a finished laminated stack of films with conductor lugs on the anode side, which are conductively connected to a first current conductor, and conductor lugs on the cathode side, which are conductively connected to a second current conductor, are preferably laid on the lower film packaging which has been cut to size. In the further production process, the upper film packaging is then applied, the inner space evacuated and the edges of the two film packagings welded or suitably connected to the current conductors in a gas-tight and liquid-tight manner. Suitable adhesion and evacuation methods are known per se and are not an element of the present invention.

1-14. (canceled)

15. A method for producing an electrochemical energy store, comprising:
applying at least one film at least partially to a housing surface or to a packaging surface of the electrochemical energy store during production of the housing of the electrochemical energy store.

16. The method according to claim 15, in which the film is applied free from folds and without air pockets.

17. The method according to claim 15, wherein the film is applied during production thereof, during deep drawing or during one or more subsequent steps involved in the production of the electrochemical energy store

18. The method according to claim 15, wherein the film is glued on, laminated on, coated, or sprayed onto the housing surface or onto the packaging surface of the electrochemical energy store.

19. The method according to claim 15, wherein a multi-layer film is applied layer by layer to the housing surface or to the packaging surface of the electrochemical energy store.

20. An electrochemical energy store with a housing or packaging, produced according to claim 15, comprising:
a film for protecting the housing surface or the packaging surface from damage, particularly during the production, transportation, or installation of the electrochemical energy store.
